(19) United States
(12) Patent Application Publication
(10) Pub. No.: US 2019/0376470 A1
(43) Pub. Date: Dec. 12, 2019

(54) JET ENGINE WITH A RADIALLY VARIABLE WALL

(71) Applicant: Rolls-Royce Deutschland Ltd & Co KG, Blankenfelde-Mahlow (DE)

(72) Inventor: Predrag TODOROVIC, Berlin (DE)

(21) Appl. No.: 16/489,193

(22) PCT Filed: Feb. 22, 2018
(86) PCT No.: PCT/EP2018/054421

§ 371 Date: Aug. 27, 2019

(30) Foreign Application Priority Data
Feb. 27, 2017 (DE) 10 2017 104 078.1

(51) Int. Cl. F02K 1/08; F02K 1/09

(52) U.S. Cl. CPC F02K 1/085; F02K 1/48; F02K 1/09

(57) ABSTRACT

A jet engine having a flow duct that is arranged in an engine nacelle and is delimited radially on the inside by a central body and radially on the outside by an outer nozzle wall is described. The free cross section of the flow duct is variable by an elastically embodied, radially variable wall of at least one of these components. The radially variable wall at least regionally has an at least approximately wavelike structure and is connected to at least one adjusting device having an adjusting unit. The variable wall of one of these components is variable in a radial direction at two defined control sections, at least one of which defines an axial wall end of the radially variable wall.

The invention relates to a jet engine having a flow duct arranged in an engine nacelle, of the type defined in more detail in the preamble of claim 1.

A large number of embodiments of jet engines having nozzles, in which a flow cross section is variable in the region of the nozzle, are known from the art. In particular in the case of a supersonic nozzle, a flow cross section should be varied in two flow cross sections in the region of the nozzle in order to adapt the cross section of a flow duct to the particular operating state. In order to vary the flow cross section in the region of the nozzle, it is known to embody a wall of the supersonic nozzle with a large number of individual parts in the circumferential direction, which are displaceable relative to one another by means of a mechanism.

Such walls and mechanisms are disadvantageously embodied in a heavy and complex manner. In addition, there are steps and gaps between the individual parts of the wall in particular operating states, these steps and gaps disadvantageously resulting in significant efficiency losses of these systems.

DE 10 2015 206 095 A1 discloses an aero gas turbine having a variable bypass nozzle, by means of which an aircraft embodied with such an aero gas turbine is operable as efficiently as possible in all flight phases. In the case of the aero gas turbine, a radially inner wall of the bypass nozzle is embodied to this end with what is known as an adjusting element, which has convex and concave regions that alternate in the circumferential direction, resulting in a wave structure in a radial section plane. The adjusting element is deformable elastically and radially outwardly. To deform the adjusting element, a piston/cylinder unit is provided, which acts on an annular element of the adjusting element by way of a tie rod. By displacement of the tie rod, a shaping of the adjusting element is variable, this also being associated with a change in cross section of the bypass nozzle.

However, with this known nozzle design, defined variable shaping of the bypass nozzle can be carried out only to a limited extent.

The present invention is based on the object of providing a jet engine, in particular a supersonic engine, having a variable flow duct, in which a high level of efficiency is achieved and in which a flow cross section of the flow duct is settable in as defined a manner as possible.

According to the invention, this object is achieved by a jet engine having the features of claim 1.

A jet engine having a flow duct that is arranged in an engine nacelle and is delimited radially on the inside by a central body and radially on the outside by an outer nozzle wall is proposed, the free cross section of the flow duct being variable by an elastically embodied, radially variable wall of at least one of these components, and the radially variable wall at least regionally having an at least approximately wavelike structure and being connected to at least one adjusting device having an adjusting unit.

According to the invention, the variable wall of one of these components is variable in a radial direction at two defined control sections, at least one of which defines an axial wall end of the radially variable wall. To this end, a connecting structure for connecting the at least one adjusting unit to the variable wall is provided, the connecting structure having a multiplicity of bar elements that are arranged in a circumferentially distributed manner and are each connected firmly to a concave region of the wall.

In the jet engine according to the invention, a flow cross section of the flow duct is advantageously settable in a defined manner by the variability in the region of the control sections, since tests have shown that a control section at a wall end or flow duct end and a further control section along the longitudinal extension of the nozzle, for example in what is known as the throat region with the smallest flowed-through cross section, allow a desired flow cross section to be set reliably.

By way of the wall that is variable in a radial direction at two significant, predefined control sections, the cross-sectional profile in the longitudinal direction of the nozzle can be easily adapted appropriately to the particular operating states, a considerable improvement in effectiveness being achievable in particular in supersonic engines.

As a result of the provision of the wavelike structure of the flexible wall, the wall is also advantageously able to be embodied in a lightweight and cost-effective manner. In addition, the wall does not have any steps or gaps that could result in turbulence and the like and thus undesired efficiency losses.

In the unactuated and therefore unextended initial state of the variable wall, the wall has in particular a corrugated-sheetlike or wavelike outer contour. Actuation of the variable wall by the adjusting device leads to an in particular axisymmetric and advantageously uniform deformation or to bulging of the variable wall with a reduction in height of the wave structure, with the result that the wave structure takes on a more circular shape. A diameter or cross-sectional area of the variable wall is in this case increased, no steps or gaps arising in the region of the variable wall even in the event of a change in shape of the wall.

The wall end can be arranged at an upstream end and/or a downstream end of the variable wall in the main direction of flow of the jet engine, in particular the arrangement at a downstream end being advantageous.

In an advantageous embodiment of the invention, the wall of the central body is embodied in a radially variable manner, in particular a region of the central body being embodied in a variable manner that is arranged in what is known as a mixing region of the jet engine, said region being located downstream of a combining region of a bypass duct with a core flow duct.

Alternatively or additionally thereto, it is also possible for an outer wall that delimits the flow duct radially on the outside, in particular an outer nozzle wall, to be embodied in a radially variable manner, large variations in a flow cross section of the flow duct being easily achievable in this region. On account of the lower temperature load here, it is accordingly possible for other materials to be used than in the case of the central body.

In principle, the radially variable wall can delimit any kind of flow duct of an aircraft engine. Here, the configuration of a flow duct of a nozzle, in particular of a supersonic nozzle, has proven to be particularly expedient.

In order to be able to set the flow duct precisely, in an advantageous embodiment of a jet engine according to the invention, two adjusting units are provided, which are each assigned to a control section of the radially variable wall. By appropriate actuation of the adjusting units, mutually independent defined setting of the radially variable wall in the particular cross-sectional region is possible here.

In an advantageously simple embodiment of a jet engine according to the invention, at least one adjusting unit is embodied as a cylinder/piston unit that acts in particular in the axial direction of the jet engine.

For the cooperation and connection of the at least one adjusting unit with/to the variable wall, a connecting structure arranged in particular centrally in the central body and embodied for example in a star-shaped manner can be provided. The connecting structure can have a multiplicity of connecting elements that are embodied for example as metal strips, are arranged in a star-shaped manner, and are connected in a manner distributed in the circumferential direction to the adjusting unit on one side and to the variable wall on the other.

Advantageous joint actuation of the adjusting units is possible when the adjusting units are coupled together. For example, it is possible for the adjusting units to be arranged one after the other in the axial direction of the jet engine, a first adjusting unit being connected to a housing of the central body in one end region and a second adjusting unit being connected to the second adjusting unit in an end region remote from the end region of the first adjusting unit. In a simple design, the adjusting units can be embodied for example as cylinder/piston units.

It is also possible for the at least one adjusting unit to be arranged on the outer wall that forms a variable wall. The adjusting unit can in this case be embodied for example in the manner of what is known as a unison ring or in the manner of a diaphragm or iris mechanism. Furthermore, the adjusting unit can also be embodied as a camshaft mechanism. In addition, the adjusting unit can be embodied in a comparable manner to an actuating mechanism of adjustable stator blades, a variation in the wave structure of the variable wall being brought about by a displacement of an actuating device.

In an advantageous and easily implementable embodiment of the invention, the radially variable wall has convex regions and concave regions that are arranged alternately with one another in the circumferential direction, the convex regions and the concave regions being formed in a sinusoidal manner in a radial section plane. Upon displacement of the variable wall, advantageously slight local expansions of the material of the variable wall arise, such that the variable wall is loaded only slightly during adjustment. As a result, large cross-sectional variations are possible and the variable wall has an advantageously long service life.

The wave structure of the variable wall can extend along the entire length of the wall in the longitudinal direction of the jet engine. Depending on the application, a person skilled in the art will also provide only particular portions of the wall with such a wave structure, however.

Both the features specified in the claims and the features specified in the following exemplary embodiments of the jet engine according to the invention are in each case suitable for developing the subject matter of the invention on their own or in any desired combination.

Further advantages and advantageous embodiments of the jet engine according to the invention will become apparent from the claims and the exemplary embodiments described in principle in the following text with reference to the drawing, the same reference signs being used for structurally and functionally identical components for clarity reasons in the description of the exemplary embodiments.

In the figures:

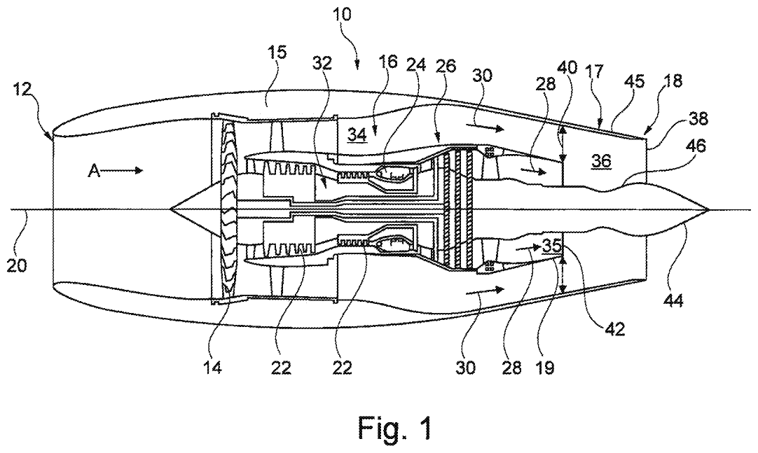

FIG. 1 shows a simplified sectional illustration of a jet engine having a bypass duct and a core flow duct, the bypass duct and the core flow duct being combined in a downstream region to form a mixing region that is delimited by a central body and an outer nozzle wall, and the central body being embodied with a radially variable wall;

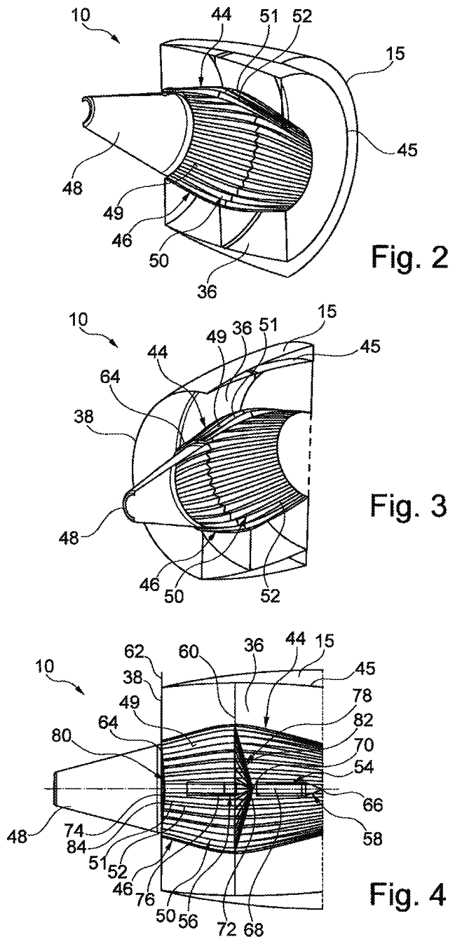

FIG. 2 shows a highly simplified three-dimensional view of the mixing region of the jet engine according to FIG. 1;

FIG. 3 shows a further highly simplified three-dimensional view of the mixing region of the jet engine according to FIG. 1;

FIG. 4 shows a simplified sectional view of the jet engine according to figure 1 in the mixing region, the wall being shown in a first operating state;

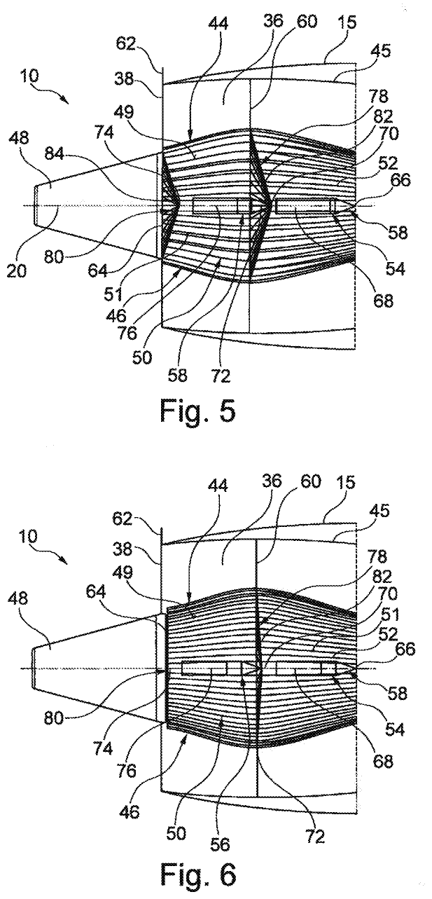

FIG. 5 shows a view corresponding to FIG. 4 of the mixing region of the jet engine, the wall being shown in a second operating state;

FIG. 6 shows a view corresponding to FIG. 4 and FIG. 5 of the mixing region of the jet engine, the wall being shown in a third operating state;

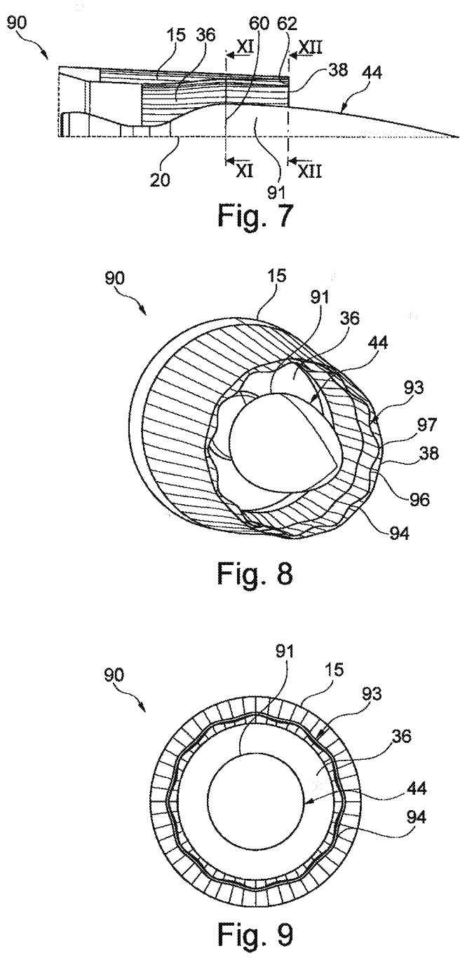

FIG. 7 shows a simplified view of a detail of a mixing region of an alternatively embodied jet engine, an outer nozzle wall being embodied in a radially variable manner;

FIG. 8 shows a simplified three-dimensional view of the mixing region according to FIG. 7;

FIG. 9 shows a simplified view of the mixing region according to FIG. 7;

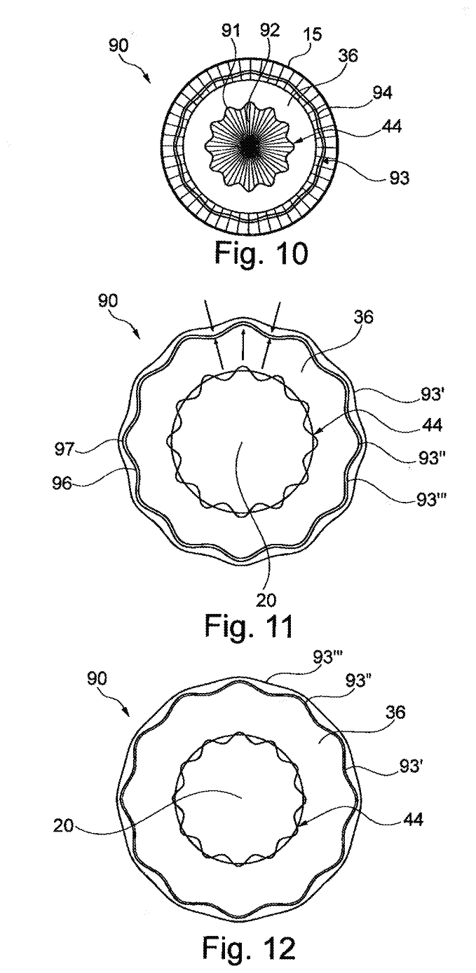

FIG. 10 shows a view corresponding to FIG. 9 of the mixing region with an alternatively embodied central body;

FIG. 11 shows a highly simplified sectional view of the mixing region according to FIG. 7 in a first cross-sectional region XI-XI; and

FIG. 12 shows a highly simplified sectional view of the mixing region according to FIG. 8 in a second cross-sectional region XII-XII.

FIG. 1 shows a jet engine or gas turbine engine 10, which comprises, in the axial direction of flow A, an air intake 12, a fan 14, a core engine 16 and a thrust nozzle arrangement 18, which are all arranged around a central axis 20 and are enclosed radially on the outside by an outer housing device 15, known as an engine nacelle. The exhaust-gas nozzle arrangement 18 comprises an outer nozzle 17 and a radially inner nozzle 19. The core engine 16 successively has, in the axial direction of flow A, a series of compressors 22, a combustion chamber 24, and a series of turbines 26.

A main direction of flow through the jet engine 10 during operation is indicated by the arrow A. The terms “upstream” and “downstream” throughout the description are used with reference to this general direction of flow A.

During operation of the jet engine 10, air is drawn in through the air intake 12 by the fan 14, accelerated and compressed. Downstream of the fan 14, the air is split into a core engine flow 28 and a bypass flow 30. The air guided through the core engine 16 flows through the core engine compressor 22, in the region of which it is compressed further. Downstream of the compressor 22, the air is mixed with fuel in the region of the combustion chamber 24, this mixture being combusted within the combustion chamber 24.

As a result of the combustion of the fuel with the compressed air, a gas flow exhibiting a high energy level and speed emerges downstream of the combustion chambers, said gas flow being guided downstream through the turbines 26. By way of turbine rotors, the turbines 26 extract energy from the high-energy gas flow, this energy being used to drive the fan 14. The compressors 22 and the fan 14 are connected to the turbine rotors by means of shafts 32 mounted in a rotatable manner about the central axis 20, and are driven thereby. Downstream of the turbines 26, the gas flow is guided as core exhaust-gas flow 28 through an outlet region 42 of the core engine 16 and into a mixing region 36.

The bypass flow accelerated by the fan 14 and guided through a bypass duct 34 flows in the direction of flow A radially outside the core engine 16. The bypass duct 34 ends in the region of an outlet opening 40 and is mixed with the core engine flow 28 downstream of the outlet opening 40 in the mixing region 36, and is discharged from the jet engine 10 in the region of an end outlet opening 38, in order to supply a desired propulsion thrust.

The thrust nozzle arrangement 18 has a central body 44, which is arranged radially within the inner nozzle 19. The central body 44 regionally defines, radially on the inside, a core flow duct 35, through which the core engine flow 28 is guided. The inner nozzle 19 and the outer nozzle 17 define the bypass duct 34 for the bypass flow 30. The outer nozzle 17 extends downstream from the inner nozzle 19, the mixing region or mixing duct 36 being defined by an outer nozzle wall 45 and a wall 46 of the central body 44. Both the core gas flow 28 and the bypass flow 30 are introduced into the mixing region 36. In the region of the end outlet opening 38, the mixing region 36 has both a diverging and a converging region.

During a conventional flight cycle, the jet engine 10 passes through different operating states, which comprise a start, a climb, a cruising flight, a descent and a landing. In addition, there can also be standby operation before a start. During a start of an aircraft, the jet engine 10 is operated at full power and during a climb, during which the aircraft climbs to cruising height, at almost full power. During the cruising flight, the jet engine 10 generally works at about 70% to 80% of its maximum power. During a descent, a power of the jet engine 10 is reduced to about 10% to 20% of the maximum power.

In order to be able to operate the jet engine 10 as effectively as possible in all operating states, a free flow cross section in the mixing region 36 is embodied in a variable manner.

To this end, a wall 46 (more readily apparent in FIG. 2 to FIG. 6) of the central body 44, said wall 46 extending in the direction of flow A for example from the outlet opening 40 of the bypass duct 34 and the outlet region 42 of the core flow duct 35 as far as a core casing 48 in the present case, is embodied with a cross section that is variable in a radial direction R. As a result of a variation in the cross section enclosed by the wall 46, a flow cross section of the mixing region 36 is also variable.

The elastically embodied wall 46 in the present case has a surface 49 that is closed in the direction of the mixing region 36, and a wave structure 50 that is continuous in the circumferential direction U and is formed by convex regions 51 and concave regions 52 that are arranged alternately with one another. The convex regions 51 and the concave regions 52 are formed in the present case in a sinusoidal manner in a radial section plane, the convex regions 51 and the concave regions 52 each extending substantially rectilinearly in the direction of flow A.

For actuation, i.e. in order to expand and contract the variable wall 46, in the present case two adjusting units, which are each embodied as cylinder/piston units 54, 56 and are coupled together, of an adjusting device 58 are provided, the first cylinder/piston unit 54 being embodied to vary a cross section of the wall 46 in the region of a first control section 60, and the second cylinder/piston unit 56 being embodied to vary a cross section of the wall 46 in the region of a second control section 62. The cylinder/piston units 54, 56 extend along the central axis 20 in a region that is central in a radial direction R of the jet engine 10.

The first control section 60 is located in the present case in the region of the mixing region 36, in which the flow duct formed by the mixing region 36 has a minimum cross section, or represents what is known as a throat region. The second control section 62 is located in the present case in a downstream end region 64 of the wall 46, which in the present case is adjoined in the direction of flow A by the core casing 48.

The first cylinder/piston unit 54 is fixed to the housing with an upstream end region 66, a piston 68 of the first cylinder/piston unit 54 being connected, in a downstream end region 70, to an upstream end region 72 of the second cylinder/piston unit 56. As a result, the second cylinder/piston unit 56 is displaced when the piston 68 of the first cylinder/piston unit 54 is displaced. A downstream end region 74 of the second cylinder/piston unit 56 is in turn embodied in a displaceable manner via a piston 76 of the second cylinder/piston unit 56.

The first cylinder/piston unit 54 is assigned a connecting structure 78, which is formed by a multiplicity of bar elements, or metal strips 82, arranged in a circumferentially distributed manner. The metal strips 82, which are arranged in a star shape, are in this case each connected, in the downstream end region 70 of the first cylinder/piston unit 54, to the piston 68 and each extend from the latter in a radial direction R outward to the wall 46. The metal strips 82 are in this case each firmly connected, in the first control section 60, to a concave region 52 of the wall 46, each concave region 52 being assigned a metal strip 82 in the present case.

In comparable manner to the connecting structure 78, the second cylinder/piston unit 56 is also assigned a connecting structure 80, which is in turn embodied with a multiplicity of for example barlike metal strips 84. The metal strips 84 are connected on one side, in the downstream end region 74 of the second cylinder/piston unit 56, to the piston 76 and extend from the latter in a radial direction R to the wall 46, and are firmly connected to the latter with the concave regions 52 in the second control section 62. In this case, a metal strip 84 is in turn assigned in particular to each concave region 52.

As a result of the respective attachment point of the metal strips 82 to the first cylinder/piston unit 54 or of the metal strips 84 to the second cylinder/piston unit 56 being displaced, a distance of the concave regions 52 from the central axis 20 is settable in the respective control section 60, 62, a displacement of the respective piston 68, 76 in the present case resulting in an axisymmetric deformation or in bulging of the variable wall 46 with a reduction in a height of the wave structure 50. In this case, depending on the material of the wall 46 and the bending behavior thereof, the convex regions 51 are deformed appropriately, the wave structure 50 being transferred into a more circular shape in the event of an increase in a distance of the concave regions 52 from the central axis 20. In this case, a distance of the convex regions 51 from the central axis 20 is also able to be increased to a maximum.

As a result of the respective cylinder/piston unit 54, 56 being displaced, a cross-sectional area of the variable wall 46 is variable in the respective control section 60, 62, a flow cross section in the mixing region 36 being varied accordingly as a result. An increase in the cross-sectional area of the wall 46 in the respective control section 60, 62 results in this case in a reduction in the flow cross section of the mixing region 36 in the respective control section 60, 62 and vice versa. A profile of a flow cross section in the mixing region 36 is in this case settable advantageously precisely by the adjusting device 58.

FIG. 2 to FIG. 4 show a first operating state of the wall 46, in which a power of the jet engine 10 is at a maximum and which occurs in particular during a start of an aircraft. The piston 68 of the first cylinder/piston unit 54 is in this case in a maximally retracted end position. As a result, a distance between the concave regions 51 and the central axis 20 is at a minimum in the first control section 60, and so the flow cross section of the mixing region 36 is at a maximum in the first control section 60. The piston 76 of the second cylinder/piston unit 54 is in a maximally extended position, and so the downstream end region 74 of the second cylinder/piston unit 56 is substantially in the region of the second control section 62 and the bar elements or metal strips 84 are also located substantially in a plane defined by the second control section 62. A distance between the concave regions 52 and the central axis 20 is in this case at a maximum in the second control section 62, with the result that, in turn, a flow cross section of the mixing region 36 is at a minimum in the second control section 62.

A second operating state of the wall 46 is shown in FIG. 5, this second operating state occurring in particular during a climb of an aircraft. The piston 68 of the first cylinder/piston unit 54 is located in this case in a central position between a maximally retracted and a maximally extended end position, and so a flow cross section of the mixing region 36 has a size in the first control section 60 that is likewise between a maximum size and a minimum size of the flow cross section. The piston 76 of the second cylinder/piston unit 54 is located in a maximally retracted position, and so a distance between the concave regions 52 and the central axis 20 is at a minimum in the second control section 62. The flow cross section of the mixing region 36 in the second control section 62 as a result adopts a maximum value.

FIG. 6 shows a third operating state of the wall 46, which occurs during a cruising flight and in particular in supersonic operation. Both the piston 68 of the first cylinder/piston unit 54 and the piston 76 of the second cylinder/piston unit 54 are in this case in a maximally extended end position, and so the respective downstream end region 70, 74 of the cylinder/piston units 54, 56 is located substantially in the region of a plane defined by the respective control section 60, 62 and the flow cross section of the mixing region 36 is at a minimum in the first control section 60 and in the second control section 62.

FIG. 7 to FIG. 12 show alternative embodiments of a jet engine 90, which is embodied substantially in a comparable manner to the jet engine 10. Therefore, in the following text, only the differences between the jet engine 90 and the jet engine 10 are discussed and otherwise reference is made to the information given in relation to the jet engine 10.

In the case of the jet engine 90, a wall 91 of the central body 44 is not embodied in a flexible manner but rather in a rigid manner, the wall 91 having a circular cross section in the circumferential direction U.

In the embodiment according to FIG. 10, the wall 91 of the central body 44 is likewise embodied in a rigid manner, but has a wave structure 92, which is formed in a comparable manner to the wave structure 50 of the wall 46 with concave regions 52 and convex regions 51. The shape of the wall 91 is in this case chosen in particular with regard to the requirements in terms of flow and/or noise.

In the embodiment of the jet engine 90 according to FIG. 7 to FIG. 12, an outer nozzle wall 93 delimiting the mixing region 36 on the outside in a radial direction R is embodied as a radially flexible wall with a wave structure 94. The wave structure 94 is in this case embodied in a comparable manner to the wave structure 50, a flow cross section, delimited by the outer nozzle wall 93, of the mixing region 36 being variable in a comparable manner to the embodiment of the jet engine 10. To this end, an adjusting device (which is not more clearly apparent) is again provided, which can be embodied with two adjusting units such that, by means of the adjusting device, a flow cross section of the mixing region 36 is variable in particular in the control sections 60, 62.

Compared with the radially flexible wall 46, with the radially flexible outer nozzle wall 93, larger variations in a flow cross section of the mixing region 36 with comparatively small bends of the outer nozzle wall 93 in the region of concave regions 96 and convex regions 97 are achievable.

FIG. 11 and FIG. 12 show the outer nozzle wall 93 in different operating states, the nozzle wall 93 being shown in the first control section 60 in FIG. 11 and in the second control section in FIG. 12. At 93′, the wall is shown in supersonic operation of the jet engine 90 at maximum power and, for example, 1.2 Ma, at 93″, it is shown in a transonic range at for example 0.95 Ma, and at 93′″, it is shown during a start (MTO).

The adjusting device, provided for displacing the elastically embodied, radially flexible outer nozzle wall 93, is arranged preferably in an intermediate space between the outer nozzle wall 93 and the engine nacelle 15. The adjusting units of the adjusting device can in this case be embodied in a manner depending on the respectively available installation space.

### LIST OF REFERENCE SIGNS

10 Jet engine
12 Air intake

### 14 Fan

15 Housing device; engine nacelle
16 Core engine
17 Outer nozzle
18 Thrust nozzle arrangement
19 Inner nozzle
20 Central axis

### 22 Compressor

24 Combustion chamber

### 26 Turbine

28 Core engine flow
30 Bypass flow

### 32 Shaft

34 Bypass duct
35 Core flow duct
36 Mixing region
38 End outlet opening
40 Outlet opening
42 Outlet region
44 Central body
45 Outer nozzle wall

### 46 Wall

48 Core casing

### 49 Surface

50 Wave structure
51 Convex region
52 Concave region
54 First adjusting unit; first cylinder/piston unit
56 Second adjusting unit; second cylinder/piston unit
58 Adjusting device
60 First control section
62 Second control section
64 Downstream end region of the wall
66 Upstream end region of the first cylinder/piston unit
68 Piston of the first cylinder/piston unit
70 Downstream end region of the first cylinder/piston unit
72 Upstream end region of the second cylinder/piston unit
74 Downstream end region of the second cylinder/piston unit
76 Piston of the second cylinder/piston unit
78, 80 Connecting structure
82, 84 Bar element
90 Jet engine
91 Wall of the central body
94 Wave structure of the central body
93 Flexible wall; outer nozzle wall
94 Wave structure
96 Concave region
97 Convex region
A Direction of flow
R Radial direction of the jet engine
U Circumferential direction of the jet engine

1. A jet engine having a flow duct that is arranged in an engine nacelle and is delimited radially on the inside by a central body and radially on the outside by an outer nozzle wall, the free cross section of the flow duct being variable by an elastically embodied, radially variable wall of at least one of these components, and the radially variable wall at least regionally having an at least approximately wavelike structure with convex regions and concave regions that are arranged alternately with one another in the circumferential direction, the convex regions and the concave regions being formed in a sinusoidal manner in a radial section plane, and being connected to at least one adjusting device having an adjusting unit, wherein the variable wall of one of these components is variable in a radial direction at two defined, axially spaced apart wall cross sections, at least one of which defines an axial wall end of the radially variable wall, a connecting structure for connecting the at least one adjusting unit to the variable wall being provided, and the connecting structure having a multiplicity of bar elements that are arranged in a circumferentially distributed manner and are each connected firmly to a-one of the concave regions of the wall.

2. The jet engine as claimed in claim 1, wherein the wall end of the variable wall represents an upstream end or a downstream end in the main direction of flow of the jet engine.

3. The jet engine as claimed in claim 1, wherein a wall cross section is arranged in a region of the variable wall in which a flow cross section of the flow duct is at a minimum.

4. The jet engine as claimed in claim 1 wherein the wall of the central body is embodied in a radially variable manner.

5. The jet engine as claimed in claim 1 wherein an outer wall that delimits the flow duct radially on the outside is embodied in a radially variable manner.

6. The jet engine as claimed in claim 1 wherein two adjusting units are provided, which are each assigned to a wall cross section of the radially variable wall.

7. The jet engine as claimed in claim 1 wherein at least one adjusting unit is embodied as a cylinder/piston unit and arranged in the central body.

8. The jet engine as claimed in claim 1 wherein the adjusting units are coupled together.

9. The jet engine as claimed in claim 1 wherein at least one adjusting unit is arranged on the outer wall.

10. (canceled)
